(19) United States
(12) Patent Application Publication
(10) Pub. No.: US 2024/0189713 A1
(43) Pub. Date: Jun. 13, 2024

(54) Cloud Gaming Image Processing and Streaming Methods and Systems

(71) Applicant: Tencent Technology (Shenzhen) Company Limited, Shenzhen (CN)

(72) Inventor: Fengkai Wu, Shenzhen (CN)

(21) Appl. No.: 18/584,546

(22) Filed: Feb. 22, 2024

Related U.S. Application Data
(63) Continuation of application No. PCT/CN2023/119521, filed on Sep. 18, 2023.

(30) Foreign Application Priority Data
Oct. 18, 2022 (CN) 202211277162.0

(51) Int. Cl. A63F 13/52; A63F 13/355; A63F 13/837; G06T 15/04; G06T 17/20

(52) U.S. Cl. CPC A63F 13/52; A63F 13/355; G06T 15/04; G06T 17/20; A63F 13/837

(57) ABSTRACT

Data processing methods and systems for cloud gaming, an electronic device, a computer-readable storage medium, and a computer program product, which can be applied to the field of data processing technologies, are described herein. The method includes: obtaining, in a game process of cloud gaming, display data transmitted by a cloud device of the cloud gaming, the display data including a to-be-displayed game picture frame and a first position of a target object in the game picture frame; displaying the game picture frame, and displaying a target control of the target object on the displayed game picture frame; and drawing the target object on the displayed game picture frame in response to a trigger operation for the target control. This application can also be applied to various scenarios such as cloud computing, artificial intelligence, intelligent transportation, assistant driving, and smart household appliances.

### RELATED APPLICATION

This application claims priority to PCT/CN2023/119521, filed Sep. 18, 2023, which in turn claims priority to Chinese Patent Application No. 202211277162.0 filed on Oct. 18, 2022, each of which is incorporated herein by reference in its entirety.

### FIELD OF THE TECHNOLOGY

This application relates to the field of data processing technologies, and in particular, to a data processing method and apparatus for improved cloud gaming image processing and streaming, an electronic device, a computer-readable storage medium, and a computer program product.

### BACKGROUND OF THE DISCLOSURE

Cloud gaming refers to games running on cloud servers. Through video technologies, game pictures generated by the cloud servers are transmitted to various terminals to display. The terminals trigger corresponding events by using peripherals such as mice, game controllers, keyboards or touch screens and transmit the corresponding events back to the cloud servers to generate new game pictures. In previous solutions, cloud gaming technologies are based on video streaming, that is, game pictures rendered by games on cloud devices are transmitted as video streaming to terminals, and the terminals display the game pictures based on the video streaming. However, due to reasons such as video encoding and compression, network latency, bandwidth constrictions, and the like, game pictures displayed by the client terminals based on the video streaming is often blurry.

### SUMMARY

Because cloud gaming-based systems often result in blurry video and/or images being rendered at the client side, it is difficult for users (gamers) to perform some necessary aspects of some games. For example, identifying a target or aiming a targeting reticle is difficult or impossible when rendered game images are blurry. Aspects described herein thus provide a data processing method and apparatus for cloud gaming, an electronic device, a computer-readable storage medium, and a computer program product, which can improve the display definition, resolution, clarity and/or detail of game pictures and video rendered via a cloud gaming system.

One aspect described herein provides a data processing method for cloud gaming, including:
obtaining, in a game process of cloud gaming, display data transmitted by a cloud device of the cloud gaming, the display data including a to-be-displayed game picture frame and a first position of a target object in the game picture frame;
displaying the game picture frame, and optionally displaying a target control of the target object on the displayed game picture frame; and
drawing the target object on the displayed game picture frame based on the first position, optionally in response to a trigger operation for the target control.

An aspect of this application provides a data processing apparatus for cloud gaming, including:
an obtaining unit, configured to obtain, in a game process of cloud gaming, display data transmitted by a cloud device of the cloud gaming, the display data including a to-be-displayed game picture frame and a first position of a target object in the game picture frame;
a display unit, configured to display the game picture frame, and display a target control of the target object on the displayed game picture frame; and
a processing unit, configured to draw the target object on the displayed game picture frame based on the first position in response to a trigger operation for the target control.

An aspect of this application provides an electronic device, including a processor and a memory, the memory being configured to store a computer program, and the processor being configured to execute the computer program stored in the memory to implement the data processing method for cloud gaming provided in the aspects of this application.

An aspect of this application provides a computer-readable storage medium, having a computer program stored therein, the computer program, when executed by a processor, implementing the data processing method for cloud gaming provided in the aspects of this application.

An aspect of this application provides a computer program product or a computer program, including computer executable instructions, the computer executable instructions, when executed by a processor, implementing the data processing method for cloud gaming provided in the aspects of this application.

With the aspects of this application, in a game process of cloud gaming, display data transmitted by a cloud device of the cloud gaming is obtained, thereby displaying a game picture frame included in the display data, and optionally displaying a target control of a target object on the game picture frame. The target object is drawn on the displayed game picture frame based on a first position of the target object included in the display data in the game picture frame, optionally based on receiving a trigger operation for the target control. Therefore, compared with the related art in which the game picture is displayed only based on video streaming transmitted by the cloud device, in the aspects of this application, when the game picture frame of the cloud gaming is displayed, the target object in the game picture frame can be drawn to be displayed. The definition of the drawn target object is higher than the definition of the target object in the game picture frame transmitted by the cloud device, thereby improving the display definition of the game picture of the cloud gaming.

### BRIEF DESCRIPTION OF THE DRAWINGS

FIG. 1 is a schematic structural diagram of a data processing system for cloud gaming according to one or more illustrative aspects described herein.

FIG. 2 is a schematic flowchart of a data processing method for cloud gaming according to one or more illustrative aspects described herein.

FIG. 3 is a schematic diagram of an effect of a game picture according to one or more illustrative aspects described herein.

FIG. 4 is a schematic diagram of a data processing procedure for cloud gaming according to one or more illustrative aspects described herein.

FIG. 5 is a schematic flowchart of a data processing method for cloud gaming according to one or more illustrative aspects described herein.

FIG. 6 is a schematic diagram of an effect of model data according to one or more illustrative aspects described herein.

FIG. 7 is a schematic diagram of an effect of model drawing according to one or more illustrative aspects described herein.

FIG. 8 is a schematic diagram of a data processing process for cloud gaming according to one or more illustrative aspects described herein.

FIG. 9 is a schematic structural diagram of a data processing apparatus for cloud gaming according to one or more illustrative aspects described herein.

FIG. 10 is a schematic structural diagram of an electronic device according to one or more illustrative aspects described herein.

### DETAILED DESCRIPTION

The technical solutions described herein are described below with reference to the accompanying drawings. The described aspects are merely some rather than all of the possible ways of performing the inventive aspects. Other ways obtained by a person of ordinary skill in the art based on the description herein without creative efforts shall fall within the scope of this application as defined by the appended claims.

Aspects described herein provide a data processing solution for cloud gaming. In a game process of cloud gaming, display data transmitted by a cloud device of the cloud gaming system is obtained, thereby displaying a game picture frame included in the display data, and displaying a target control of a target object on the game picture frame. When a trigger operation for the target control is received, in response to the trigger operation for the target control, the target object is drawn on the displayed game picture frame based on a first position of the target object included in the display data in the game picture frame. Therefore, compared with the related art in which the game picture is displayed only based on video streaming transmitted by the cloud device, in aspects described herein, when the game picture frame of the cloud gaming is displayed, the target object in the game picture frame can be drawn locally to be displayed in finer detail. The definition of the client drawn target object is higher than the definition of the target object in the game picture frame transmitted by the cloud device, thereby improving the display definition of the game picture of the cloud gaming system.

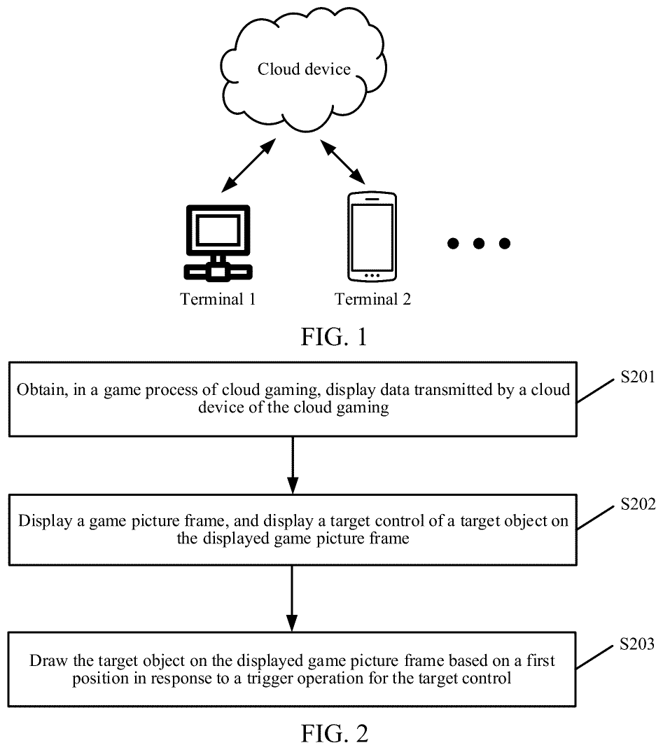

FIG. 1 is an illustrative schematic structural diagram of a data processing system for cloud gaming. The data processing system for cloud gaming may include a cloud device and a terminal (FIG. 1 illustratively shows a terminal 1 and a terminal 2). The cloud device may be a backend processing device for cloud gaming and may be configured to provide a cloud gaming service to a user. For example, the cloud device may generate a game picture frame through rendering based on a user operation event on the terminal. The user operation event may be an event generated by the terminal based on a detected user operation or input. The user operation event may be configured for indicating changes in a game picture, so that the cloud device generates a to-be-displayed game picture frame through rendering based on an indication of the user operation event, and transmits display data including the to-be-displayed game picture frame to the terminal, for the terminal to display the game picture. For example, the cloud device may transmit display data to the terminal, and the display data may include a to-be-displayed game picture frame. The terminal may display a game picture of cloud gaming, that is, may display the included game picture frame based on the display data transmitted by the cloud device, and the terminal may be configured to receive a user operation in the cloud gaming and transmit a generated user operation event to the cloud device. The terminal may also execute the foregoing data processing solution for cloud gaming, so that the target control for the target object that needs to be clearly displayed may be displayed on the received to-be-displayed game picture frame. Generally, if the game picture changes greatly in the process of the cloud gaming (for example, the character in the game is moving quickly), or the target object is small, the target object in the game picture frame generated by the cloud device is often blurry, which affects the cloud gaming experience of the user. However, through the data processing solutions described herein, when the user wants to view a clear target object, the target control corresponding to the target object may be triggered. The terminal draws the target object on the displayed game picture frame in response to the trigger operation for the target control of the target object. The definition of the drawn target object is higher than the definition of the target object in the game picture frame transmitted by the cloud device, so that the user can view the target object more clearly. In this way, the display definition of the game picture in the process of the cloud gaming can be improved, thereby improving the gaming experience in the process of the cloud gaming.

Aspects described herein may be applied to the field of cloud technologies, and may be specifically applied to the field of cloud computing. For example, data is processed by the cloud device in the game process of the cloud gaming system. Cloud computing may refer to a computing mode, in which computing tasks are distributed on a resource pool formed by a large quantity of computers, so that various application systems can obtain computing power, storage space, and information services according to various requirements. A network that provides such resources is referred to as a “cloud”. For a user, resources in a “cloud” seem to be infinitely expandable, and can be obtained readily, used on demand, expanded readily, and paid for use.

As a basic capability provider of cloud computing, a cloud computing resource pool (briefly referred to as a cloud platform, and may be referred to as Infrastructure as a Service, (IaaS)) platform is established, and various types of virtual resources are deployed in the resource pool for an external client to choose to use. The cloud computing resource pool mainly includes: a computing device (a virtualized machine, including an operating system), a storage device, and a network device. The cloud computer resource pool may include multiple of each.

Based on logical functions, a Platform as a Service (PaaS) layer may be deployed on an IaaS layer, and a Software as a Service (SaaS) layer may be further deployed on the PaaS layer, or the SaaS may be deployed directly on IaaS. PaaS is a platform for software running, such as a database, and a web container. SaaS is a variety of service software, such as a web portal website, and an SMS bulk sender. Generally, SaaS and PaaS are upper layers relative to IaaS.

One or more aspects described herein may also be applied to the field of artificial intelligence technologies. Artificial intelligence (AI) is a theory, a method, a technology, or an application system that simulates, extends, and expands human intelligence by using a digital computer or a machine controlled by the digital computer, to perceive an environment, obtain knowledge, and obtain an optimal result by using the knowledge. In other words, the AI is a comprehensive technology in computer science and attempts to understand the essence of intelligence and produce a new intelligent machine that can react in a manner similar to human intelligence. The AI is to study design principles and implementation methods of various intelligent machines, to enable the machines to have functions of perception, reasoning, and decision-making.

The AI technology is a comprehensive discipline, relating to a wide range of fields, and involving both a hardware-level technology and a software-level technology. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning.

This application can display a prompt interface or a pop-up window, or output voice prompt information before and during collecting user-related data of a user. The prompt interface, the pop-up window, or the voice prompt information is configured for informing the user that data related to the user is currently being collected, so that this application only starts to perform related steps of obtaining the user-related data after obtaining acknowledgement from the user through the interface or the pop-up window, otherwise (that is, when the confirmation operation of the user for the prompt interface or the pop-up window is not obtained), the system may end the related steps of obtaining the user-related data, that is, skips obtaining the user-related data. In other words, all user data collected by this application is collected with the consent and authorization of the user, and the collection, use and processing of user-related data need to comply with relevant laws, regulations and standards of relevant countries and regions.

One or more aspects described herein may be applied to an electronic device. The electronic device may be a terminal (such as a terminal 1 or a terminal 2 shown in FIG. 1), a server, or another device for data processing. This is not limited in this application. In some aspects, the server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal includes, but not limited to, a mobile phone, a computer, a smart speech interaction device, a smart household appliance, an in-vehicle terminal, an aircraft, a smart speaker, and the like. The terminal and the server may be directly or indirectly connected in a wired or wireless communication manner. This is not limited in the aspects of this application.

It may be understood that, the foregoing scenarios are only for example, and do not constitute a limitation to application scenarios of the technical solutions described herein, and the technical solutions described herein may also be applied to other scenarios. For example, a person of ordinary skill in the art may know that as a system architecture evolves and a new service scenario emerges, the technical solutions described herein are also applicable to a similar technical problem.

Based on the foregoing descriptions, one or more aspects described herein provide data processing methods for cloud gaming. FIG. 2 is an illustrative schematic flowchart of a data processing method for cloud gaming. The method may be performed by the foregoing electronic device. The data processing method for cloud gaming may include the following steps:

S201. Obtain, in a game process of a cloud gaming system, display data transmitted by a cloud device of the cloud gaming system.

Cloud gaming is a game mode based on cloud computing. In a running mode of the cloud gaming system, a game process is mainly run on a server side (for example, a cloud device), and a rendered game picture is compressed and transmitted to a terminal corresponding to a game player through a network, so that the terminal may display the rendered game picture transmitted by the cloud device. The cloud gaming system may include games corresponding to various platforms such as mobile games, console games, PC games, and other client games. It may be understood that, after the user clicks a control configured for indicating to enter a cloud gaming mode on the terminal and successfully enter the cloud gaming, it represents that the user is in a cloud gaming game process. In the game process, in response to user operation events transmitted by the terminal (e.g., user inputs to control the game), the cloud device may constantly generate game picture frames of the cloud gaming and transmit the game picture frames of the cloud gaming to the terminal to display, e.g., via video streaming with metadata.

The display data may include a to-be-displayed game picture frame and metadata indicating a first position of a target object in the game picture frame. The target object may be an object that needs to be clearly displayed in the game picture frame, that is, the target object can be clearly displayed by drawing the target object on the client side.

The game picture frame may be a video frame of a game picture rendered by the cloud device in the game process of the cloud gaming. Cloud gaming may be based on video streaming. The terminal of the user may constantly receive and display a plurality of game picture frames from the cloud device, so that an ever-changing game picture is formed. Each game picture frame is rendered by the cloud device, transmitted to the client device, and displayed on the client device.

The target object that needs to be clearly displayed may usually be some objects that tend to be blurry in the game picture but need to be clearly displayed for a consistent user experience. For example, the object that needs to be clearly displayed may be key objects in the game picture, such as some treasure chests, targeting reticles, and virtual object models in the game process. In some aspects, the object that needs to be clearly displayed may be a preset object. The object that needs to be clearly displayed usually has corresponding 3D model data. In other words, when the cloud device generates the game picture frame, a corresponding object may be rendered based on the 3D model data of the object, to obtain a game picture frame including the object.

The first position may indicate a position of the target object that needs to be clearly displayed. In some aspects, the first position may be represented as position coordinate information of a reference point of the target object, and the position coordinate information may be two-dimensional coordinate information (including a horizontal coordinate and a vertical coordinate). For example, the first position may be represented as position coordinate information of a center position of the target object in a particular frame, such as a horizontal coordinate and a vertical coordinate of the center position. In another example the first position may be position coordinate information corresponding to a position at a rightmost side of the target object. In some aspects, the first position of the target object may also be represented as regional position information of a region in which the target object is located. The region in which the target object is located may be configured for indicating a region that just frames the target object in a shape. If the region in which the target object is located is a rectangular region, the first position of the target object may be represented as regional position information of the rectangular region, for example, represented as position coordinate information of an upper left vertex of the rectangular region and a length and a width of the rectangular region. The first position information can thus be in any format that identifies a particular location to display a corresponding target object.

It may be understood that, if a to-be-displayed game picture frame included in display data includes an object that needs to be clearly displayed, the display data includes the first position; or if a to-be-displayed game picture frame included in display data does not include an object that needs to be clearly displayed, the display data does not include the first position.

S202: Display the game picture frame, and display a target control of the target object on the displayed game picture frame.

Herein, after the display data of the cloud gaming transmitted by the cloud device is obtained, the display data is parsed to obtain the game picture frame included in the display data and the first position of the target object, so that the game picture frame is displayed. When the game picture frame is displayed, the target control of the target object is further displayed on the displayed game picture frame. When the user wants to view a clearer target object, the target control of the target object may be triggered to cause the electronic device to draw the target object, so that the drawn target object is displayed. However, the definition of the drawn target object tends to be higher than the definition of the target object in the game picture frame transmitted by the cloud device, thereby improving the display definition of the target object in the game picture frame, that is, improving the display definition of the game picture frame.

In some aspects, the target control of the target object may be displayed on the displayed game picture frame in the following manners: displaying the target control at a second position associated with the first position on the displayed game picture frame.

The second position may be a position configured for displaying the target control for the target object, and the second position may be associated with the first position of the target object on the game picture frame. The target control may be a control configured for controlling clear display of the target object, that is, the target control may be triggered to draw the target object to implement the clear display of the target object.

In some aspects, if the first position is represented as position coordinate information of a reference point of the target object, the second position may represent position coordinate information associated with the position coordinate information of the first position. The second position may be the same as the first position, that is, the second position may also be the position coordinate information of the reference point of the target object. The second position may also be different from the first position, and the position coordinate information of the second position may be calculated based on the position coordinate information of the first position. For example, corresponding values may be added to and subtracted from the horizontal coordinate and the vertical coordinate of the position coordinate information of the first position, that is, the second position may be a position that maintains a target distance from the first position in a target direction. For example, the second position may be a position on a right side of the first position and 10 pixels away from the first position.

In some aspects, if the first position is represented as regional position information of a region in which the target object is located, the second position may be position coordinate information associated with the region in which the target object is located. For example, the second position may be position coordinate information of an upper left vertex of a rectangular region in which the target object is located. In another example, the position coordinate information of the second position may be calculated by the position coordinate information of the upper left vertex of the rectangular region in which the target object is located. This is not limited herein.

The control (that is, the target control) described herein may be equivalent to a function item and may have a plurality of presentation forms, such as a graphic button, a progress bar, a menu, a list, and an icon. This is not limited herein. For example, the target control may be displayed as an icon to prompt that an object indicated by the icon may be drawn for clear display. For example, the target control may be displayed as a magnifying glass icon to prompt that an object corresponding to the magnifying glass icon may be drawn for clear display.

By applying the foregoing aspects, the target control of the target object can be displayed in a variety of positions, which improves the display effect of the target control and the diversity of display modes, thereby improving the cloud gaming experience of the user. In addition, when the user wants to view a clearer target object, the target control of the target object may be triggered to cause the electronic device to draw the target object, so that the drawn target object is displayed. However, the definition of the drawn target object tends to be higher than the definition of the target object in the game picture frame transmitted by the cloud device, thereby improving the display definition of the target object in the game picture frame, that is, improving the display definition of the game picture frame.

In some aspects, whether the target control needs to be displayed may be determined in the following steps: detecting whether the to-be-displayed game picture frame included in the display data transmitted by the cloud device includes an object that needs to be clearly displayed, and if the object that needs to be clearly displayed is included, displaying the game picture frame, and displaying the target control at the second position indicated by the first position on the displayed game picture frame based on the first position included in the display data; or if the object that needs to be clearly displayed is not included, displaying the game picture frame and skipping displaying the target control. The detecting whether the to-be-displayed game picture frame included in the display data transmitted by the cloud device includes an object that needs to be clearly displayed may be determined by detecting whether the display data includes the first position of the target object that needs to be clearly displayed in the game picture frame. If the display data includes the first position of the object that needs to be clearly displayed, it represents that the to-be-displayed game picture frame includes the object that needs to be clearly displayed, or if the display data does not include the first position of the object that needs to be clearly displayed, it represents that the to-be-displayed game picture frame does not include the object that needs to be clearly displayed. In other words, if the game picture frame includes the object that needs to be clearly displayed, when the game picture frame is displayed, the target control for the object that needs to be clearly displayed also needs to be displayed, or if the game picture frame does not include the object that needs to be clearly displayed, the game picture frame may be displayed directly and there is no need for additional display of the target control.

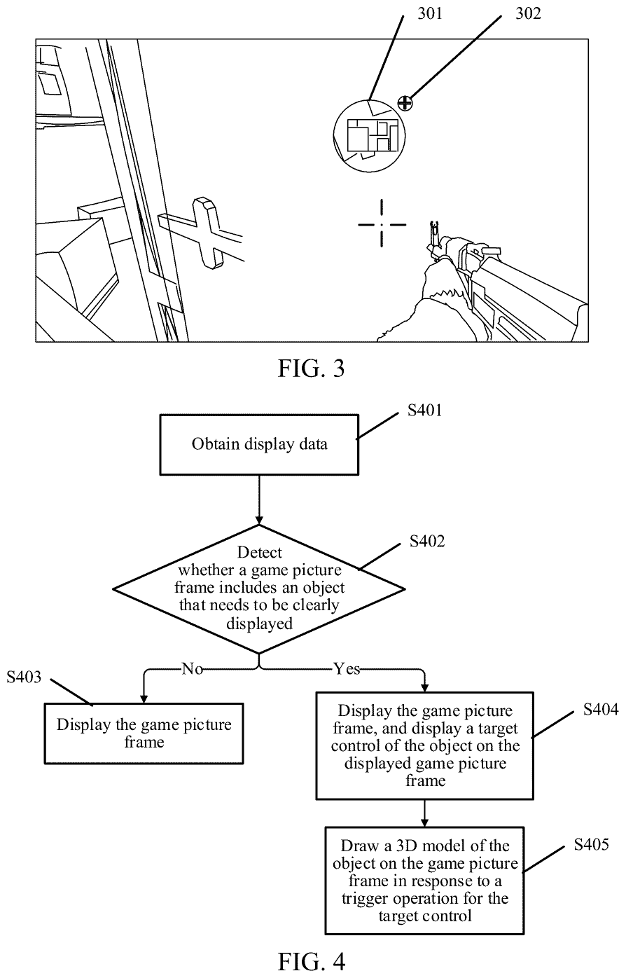

For example, FIG. 3 is a schematic diagram of an effect of game picture frames according to one or more illustrative aspects described herein. It may be seen that FIG. 3 shows a game picture frame of a shooting game rendered via a cloud gaming system. In the game picture frame, a target object 301 needs to be clearly displayed, and target control 302 near target object 301 also needs to be clearly displayed, to facilitate prompting the user that target object 301 can be clearly displayed by drawing the target object.

In some aspects, an object boundary of the target object in the game picture frame may also be determined, a marker stroke is further added to the object boundary, and the target control is added at the second position indicated by the first position. Therefore, it can be more highlighted that the target object has a function of being drawn to be clearly displayed, which improves cloud gaming experience of the user.

In some aspects, the displaying the target control on the displayed game picture frame may be processed by a target control management component. The target control management component may be configured to determine a display position (that is, the second position) of the target control that needs to be displayed, or may be configured to determine an icon style of the target control. This is not limited herein. Further, by updating the target control management component, the display position and the icon style of the displayed target control are updated. Therefore, the management of the target control is implemented through an independent component, which avoids an effect of a processing logic for the display of the target control on the game process of the cloud gaming, properly allocates processing resources of a hardware device, and improves the cloud gaming experience of the user.

Next, in step S203, the client device draws the target object on the displayed game picture frame based on the first position in response to a trigger operation for the target control.

Drawing the target object may refer to drawing a 3D model of the target object. The trigger operation for the target control may be configured for indicating the clear display of the target object, and further the terminal may draw and display the 3D model of the target object on the game picture frame based on the first position in response to the trigger operation for the target control. The definition of the 3D model of the target object is higher than the definition of the target object displayed in the game picture frame, thereby improving the display definition of the target object in the game picture frame, that is, improving the display definition of the game picture frame. The trigger operation described herein may be any operation that can trigger a corresponding function, such as a click operation, a double-click operation, and a drag operation.

In some aspects, the trigger operation for the target control may be a touch operation for the target control. For example, when the user clicks the target control, the terminal may detect the trigger operation for the target control. The trigger operation for the target control may alternatively be a shortcut key operation configured for indicating clear display of an object. For example, when the game picture frame including the target control is displayed and the user clicks the shortcut key configured for indicating the clear display of the object, the terminal may detect the trigger operation for the target control.

In some aspects, the drawing a 3D model of the target object on the displayed game picture frame may include the following steps: obtaining indication information configured for drawing the 3D model; and drawing the 3D model of the target object on the displayed game picture frame based on an indication of the indication information.

The indication information configured for drawing the 3D model is configured for indicating how to draw the 3D model of the object. For example, the indication information configured for drawing the 3D model may include a plurality of drawing instructions configured for drawing the 3D model, so that the 3D model of the object may be drawn by using the drawing instructions.

In some aspects, the drawing a 3D model of the target object on the displayed game picture frame based on the indication information may include the following steps: obtaining model data of the target object based on the indication information; and drawing the 3D model of the target object on the displayed game picture frame based on the model data of the target object and the indication information.

The model data of the target object may be data configured for drawing the 3D model of the target object. For example, the model data of the target object may include vertex data, texture data, color data, and normal data of the 3D model corresponding to the target object. This is not limited herein. The 3D model of an object usually includes a plurality of vertexes (also referred to as model key points), and the vertex data may be configured for indicating position information of each vertex (model key point) of the 3D model of the object. The texture data may be configured for indicating a texture image corresponding to each model triangular facet of a plurality of model triangular facets (also referred to as triangle meshes) formed by the plurality of vertexes included in the model data. The model triangular facet may be determined based on three vertexes. By constructing the model triangular facet of the target object, a model structure of the 3D model of the object may be determined. The color data may be configured for indicating edges between the vertexes or a color corresponding to each model triangular facet. The normal data may be configured for indicating the vertexes or orientations of the model triangular facets. In this way, the model data of the object may be processed based on the indication information to draw the 3D model of the target object.

In some aspects, as described above, the model data of the target object may include the model key points and the texture image of the target object, and the drawing the 3D model of the target object on the displayed game picture frame based on the model data of the target object and the indication information may include the following steps:
1. Construct a model triangular facet of the target object based on the model key points of the target object and the indication information. The model triangular facet may be determined based on three vertexes. By constructing the model triangular facet of the target object, a model structure of the 3D model of the object may be determined.
2. Draw the texture image on the constructed model triangular facet of the target object based on the indication information, to obtain the drawn 3D model of the target object. The texture image may be configured for indicating a texture that needs to be drawn on any model triangular facet. The texture image drawn on the model triangular facet may be indicated by the texture data, so that a corresponding texture image may be drawn on each model triangular facet, which is equivalent to drawing the texture on the constructed model structure, thereby obtaining the 3D model of the target object.
3. Display the 3D model of the target object on the displayed game picture frame. Displaying the 3D model on the game picture frame can display the target object with higher definition, so that the user can view the clearer target object, thereby improving the gaming experience.

In some aspects, when the 3D model of the target object is displayed on the game picture frame, the 3D model may be displayed based on a model proportion. For example, the model proportion may be the same proportion as a size of the target object in the game picture frame, or may be a size proportion determined based on a size of a display region of the terminal, that is, the model proportion of the displayed 3D model is adapted to the size of the display region of the terminal. In this way, the display resource utilization and display effect can be improved.

In some aspects, the drawing the target object on the displayed game picture frame based on the first position may include the following steps: determining a third position associated with the first position on the displayed game picture frame; and drawing the target object at the third position on the displayed game picture frame. The third position is associated with the first position, and the third position may be the same as the first position, or may be different from the first position. The third position may be the same as the second position, or may be different from the second position, that is, the third position may be any position in the game picture frame. For example, the third position may be a center position of the display region of the terminal, or may be a position of the target object in the game picture frame. This is not limited herein. In this way, the drawn target object can be flexibly displayed and the degree of freedom in the display position of the target object can be improved. For example, the user may also move the display position of the drawn target object through a drag operation to improve the cloud gaming experience of the user.

In some aspects, the drawn 3D model may be displayed directly at the first position of the target object in the game picture frame (that is, the drawn 3D model is used to replace the target object in the game picture frame), or the game picture frame transmitted by the cloud device may be used as a background to display the drawn 3D model on the game picture frame. For example, the game picture frame as the background may also be blurred or masked to highlight the drawn 3D model. In some aspects, the drawn 3D model may also be displayed on the game picture in a form of a pop-up window page. The size of the pop-up window page may be smaller than the size of a display region of the game picture frame. The background of the 3D model displayed in the pop-up window page may be determined based on a preset background image, or may be determined based on a screenshot of a region in which the target object is located in the game picture frame. This is not limited herein.

For example, in some examples, when the model proportion of the 3D model is the same as the size of the target object in the game picture frame, and the display position of the 3D model may be the position of the target object in the game picture frame, after the 3D model is displayed on the game picture frame, it may be intuitively seen that a clearer 3D model is displayed on the original position of the target object. In this way, the definition of the target object is improved, that is, the display definition of the game picture frame is improved, so that the cloud gaming experience of the user can be improved.

In another example, in some examples, the model proportion of the 3D model may be a proportion adapted to the size of the display region of the terminal, and the position in which the 3D model is displayed may be a center position of the display region of the terminal. When the 3D model is displayed, the displayed game picture frame is used as a background. For example, the game picture frame used as the background may also be blurred or masked. In this way, the user can focus on the displayed 3D model, so that the user can see details of the target object more clearly, and the user experience can be improved.

The data processing process is described herein with reference to the accompanying drawings. FIG. 4 is a schematic flowchart of an illustrative data processing method for cloud gaming. First, display data may be obtained (as shown by step $401), where the display data may include a to-be-displayed game picture frame. Therefore, whether the game picture frame includes an object that needs to be clearly displayed may be detected (as shown by step S402). For example, whether there is a first position of an object that needs to be clearly displayed in the display data or whether there is an object identifier of an object that needs to be clearly displayed in the display data may be detected. If the game picture frame does not include the object that needs to be clearly displayed, the game picture frame may be displayed (as shown by step S403); or if the game picture frame includes the object that needs to be clearly displayed, the game picture frame may be displayed, and a target control of the object may be displayed on the displayed game picture frame (as shown by step S404). Further, when the trigger operation for the target control is detected, the 3D model of the object may be drawn on the game picture frame in response to the trigger operation for the target control (as shown by step S405).

Using one or more illustrative aspects described herein, display data transmitted by a cloud device of a cloud gaming system is obtained, thereby displaying a game picture frame included in the display data, and displaying a target control of a target object on the game picture frame. When a trigger operation for the target control is received, in response to the trigger operation for the target control, the target object is drawn on the displayed game picture frame based on a first position of the target object included in the display data in the game picture frame. Therefore, compared with prior techniques in which the game picture is displayed only based on video streaming transmitted by the cloud device, in aspects described herein, when the game picture frame of the cloud gaming is displayed, the target object in the game picture frame can be drawn by the client device to be displayed with more clarity. The definition of the client-drawn target object is higher than the definition of the target object in the game picture frame transmitted by the cloud device, thereby improving the display definition of the game picture of the cloud gaming system.

FIG. 5 is an illustrative schematic flowchart of a data processing method for cloud gaming. The method may be performed by the foregoing electronic device. The data processing method may include the following steps:

S501. Obtain, in a game process of cloud gaming, display data transmitted by a cloud device of the cloud gaming system.

In some aspects, as described above, the to-be-displayed game picture frame in the display data may be rendered by the cloud device. For example, the cloud device may perform rendering in a corresponding manner based on a platform of a terminal that needs to be displayed. For example, for Windows games, a Direct3D graphics drawing interface may be used to call different GPU drivers for drawing. In another example, for Android mobile games, an OpenGL graphics drawing interface may be used to call different GPU drivers for drawing to obtain the game picture frame.

In some aspects, the to-be-displayed game picture frame transmitted by the cloud device may be transmitted in a compressed video format, and the obtaining the to-be-displayed game picture frame in the display data transmitted by the cloud device of the cloud gaming may include the following steps: obtaining compressed video data transmitted by the cloud device of the cloud gaming, and perform video decompression on the compressed video data to obtain the to-be-displayed game picture frame. It may be understood that, the compressed video data may be obtained by performing, after the cloud device draws the game picture frame, video compression on the drawn game picture frame. Therefore, the transmission efficiency of the game picture frame can be improved and the smoothness of picture conversion in the game process can be ensured.

S502: Display a game picture frame, and display a target control at a second position indicated by a first position on the displayed game picture frame.

For step S502, reference may be made to related descriptions of the foregoing step S202, and details are not described herein again.

S503: Draw a 3D model of a target object on the displayed game picture frame based on the first position in response to a trigger operation for the target control.

In some aspects, the indication information configured for drawing the 3D model may be pulled from the cloud device, and format conversion may be performed on the indication information pulled from the cloud device to obtain indication information adapted to the cloud gaming. Specifically, the following steps may be included: pulling initial indication information configured for drawing the 3D model to the cloud device; and performing format conversion on the initial indication information to obtain indication information adapted to the cloud gaming, and storing the indication information. To adapt to cloud gaming applied to different platforms, the initial indication information directly pulled from the cloud device may be a set of indication information in a common format, so that after receiving the initial indication information in the common format, the terminal performs format conversion on the initial indication information to obtain indication information adapted to the cloud gaming.

The indication information adapted to the cloud gaming is the indication information adapted to the platform corresponding to the terminal running the cloud gaming. If the cloud gaming is client games (for example, Windows games), the indication information adapted to the cloud gaming may be indication information adapted to the Windows games, and if the cloud gaming is mobile games (for example, mobile phone games), the indication information adapted to the cloud gaming may be indication information adapted to the mobile games. In some aspects, a timing for pulling the initial indication information may be when the cloud gaming starts game, or when the trigger operation for the target control is detected. This is not limited herein.

Then, the obtaining the indication information configured for drawing the 3D model in response to the trigger operation for the target control may include the following step: obtaining stored indication information in response to the trigger operation for the target control. In other words, the indication information configured for drawing the 3D model may be pre-stored in a storage region of the terminal. When the 3D model of the target object needs to be drawn, the stored indication information is obtained from the storage region, and the indication information is adapted to the cloud gaming, thereby improving the drawing efficiency of the 3D model.

In some aspects, the model data of the target object may also be pulled from the cloud device. Then, some aspects may further include the following steps: pulling model data of at least one object and an object identifier of the at least one object in the cloud gaming from the cloud device; and respectively storing an object identifier and model data of each object of the at least one object in association. The model data of the object is configured for drawing the 3D model of the object.

The at least one object may be an object that needs to be clearly displayed in a process of cloud gaming, the object that needs to be clearly displayed may be a preset object, and the object that needs to be clearly displayed may be all or some objects with 3D model data stored in the cloud device. This is not limited herein. Each object may have a corresponding object identifier, so that the object identifier may be stored in association with the model data of the object, and the model data of the target object may be quickly obtained from the storage region. In this way, through the indication information, the 3D model of the target object is drawn based on the model data of the target object. In some aspects, a timing for pulling model data of at least one object and an object identifier of the at least one object in the cloud gaming from the cloud device may be when the cloud gaming starts game, or when the trigger operation for the target control is detected. This is not limited herein. In this way, the model data configured for drawing the 3D model can be quickly obtained through the object identifier, so that the drawing efficiency of the 3D model can be improved.

In some aspects, the display data may further include an object identifier of the target object, so that the model data of the target object may be obtained through the object identifier of the target object. In this way, the drawing the 3D model of the target object on the displayed game picture frame in response to the trigger operation for the target control may specifically include the following steps: obtaining model data stored in association with the object identifier of the target object in response to the trigger operation for the target control; and drawing the 3D model of the target object on the displayed game picture frame based on the obtained model data. As described above, the object identifier of the object is stored in association with the model data of the object, so that after the object identifier of the target object is determined, the model data of the target object may be quickly obtained from the storage region. The drawing the 3D model of the target object on the displayed game picture frame based on the obtained model data may also specifically be drawing the 3D model of the target object based on the obtained model data and the indication information. This is not limited herein.

In some aspects, the cloud device may include a data interception component. When detecting a data pull instruction transmitted by the terminal, the cloud device calls the data interception component to obtain model data of at least one object that needs to be clearly displayed and indication information configured for drawing the model, and then transmits the obtained model data of the at least one object that needs to be clearly displayed and the indication information configured for drawing the model to the terminal. The data pull instruction may be an instruction indicating to pull model data of at least one object, or may be an instruction indicating to pull indication information. This is not limited herein. The data interception component may be configured to intercept model data involved in the cloud gaming and the indication information configured for drawing the model. It may be understood that, the cloud gaming may be connected to terminals and channels of different platforms and does not have source code. When the model data of the object is obtained, the model data of the object in the cloud gaming is pre-saved through the data interception component hooking the graphics drawing interface. The model data includes vertex data, texture data, normal data, and color data of the object. This is not limited herein. The graphics drawing interface may also be referred to as a drawing instruction, which is a set of public program access standards. Intercepting the indication information configured for drawing the 3D model is intercepting the drawing instruction, which is also referred to as intercepting the graphics drawing interface and parameters.

For example, the data interception component may be renderdoc (a data interception component), gapid (a data interception component), or the like, so that data in the cloud gaming rendered by using D3D (a graphics drawing interface) and OpenGL (a graphics drawing interface) may be intercepted and then transmitted to the terminal.

In some aspects, the cloud device may also perform information transfer on the indication information intercepted through the data interception component, to convert the indication information into initial indication information in a common format. Therefore, the initial indication information in the common format may be transmitted to terminals on various platforms, so that the terminal may perform format conversion based on the initial indication information in the common format to obtain indication information that model drawing can be directly performed on the terminal. In this way, the cloud device does not need to transmit indication information in different formats for terminals on different platforms, thereby improving the pull efficiency and accuracy of the indication information and reduces the usage of processing resources of the cloud device.

Format conversion may be performed between the initial indication information in the common format and indication information adapted to various platforms that the cloud gaming can support. For example, format conversion may be performed between the initial indication information in the common format and indication information such as Direct3D (a graphics drawing interface), OpenGL (a graphics drawing interface), Metal (a graphics drawing interface), and Vulkan (a graphics drawing interface). For example, Direct3D (adapted to Windows games) and OpenGL (adapted to mobile games) may be converted into a universal drawing interface (that is, indication information, also referred to as a drawing interface, a graphics drawing interface, and a drawing instruction) on the cloud device, so that a drawing interface adapted to a corresponding platform may be obtained on the terminal through format conversion. For example, if the terminal has Mac (an operating system) and iOS (an operating system), it is converted into Metal (a drawing instruction), if the terminal has Windows (an operating system), it is converted into Direct3D (a drawing instruction), and if the terminal has Android (an operating system) or Linux (an operating system), it is converted into OpenGL (a drawing instruction) or Vulkan (a drawing instruction).

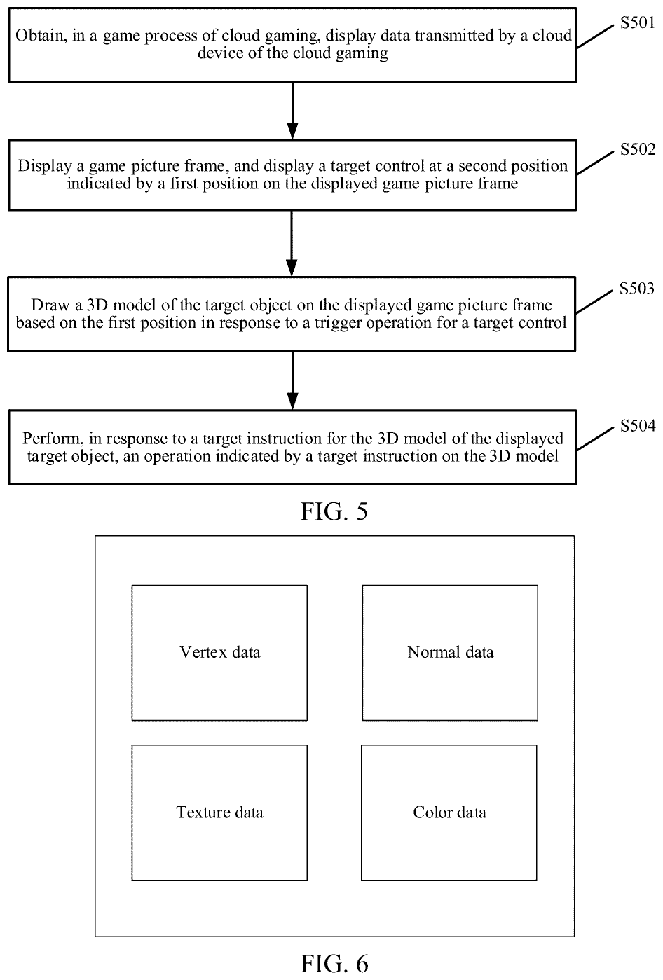

FIG. 6 is an illustrative schematic diagram of an effect of model data. As shown in FIG. 6, the model data captured by the cloud device may include model data of the 3D model of the object. The model data may include vertex data, texture data, normal data, and color data of the object.

In some aspects, the indication information may include a plurality of drawing instructions, and terminals on different platforms may use drawing instructions in corresponding formats for drawing. When a target 3D model is drawn, the 3D model may be drawn by calling the plurality of drawing instructions. The plurality of drawing instructions may include: a buffer creation instruction, a data buffer instruction, a texture creation instruction, a shader creation instruction, and a draw index instruction.

For example, a buffer handle of the model data of the target object may be determined through the buffer creation instruction. For example, for client games, the buffer creation instruction may be CreateBuffer (a drawing instruction), and for mobile games, the buffer creation instruction may be glCreateBuffer (a drawing instruction). Then, the data buffer instruction is called to load the model data of the target object into a buffer region. For example, for client games, the data buffer instruction may be IASetVertexBuffers (a drawing instruction), and for mobile games, the data buffer instruction may be glBufferData (a drawing instruction). Then, a texture image that needs to be added to each model triangular facet of the target object is determined through the texture creation instruction. For example, for client games, the texture creation instruction may be CreateTexture2D (a drawing instruction), and for mobile games, the texture creation instruction may be glTexImage2D (a drawing instruction). Further, a drawing program that can be executed by a graphics processing unit (GPU) of the terminal is created through the shader creation instruction, so that the graphics processing unit can determine a storage position of data required to draw the 3D model. For example, for client games, the shader creation instruction may be Create VertextShader (a drawing instruction), and for mobile games, the shader creation instruction may be glShaderSource (a drawing instruction). Finally, the draw index instruction is called to determine which vertexes of the 3D model need to be drawn by a graphics drawing processor, so that model drawing of the 3D model of the target object is implemented. For example, for client games, the draw index instruction may be DrawIndexed (a drawing instruction), and for mobile games, the draw index instruction may be glDrawElement (a drawing instruction).

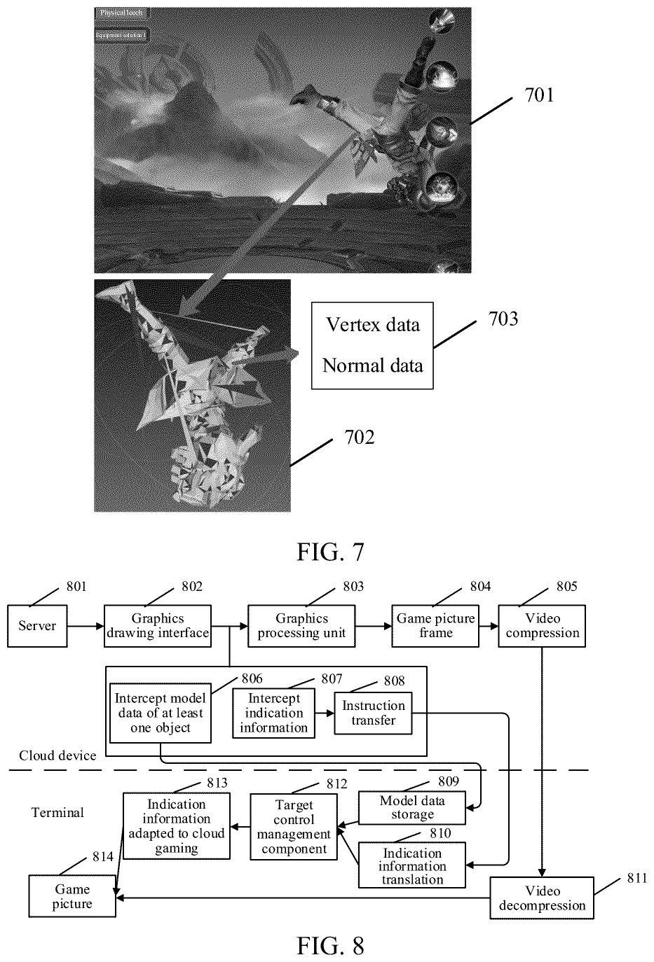

For example, FIG. 7 is an illustrative schematic diagram of an effect of model drawing. In FIG. 7, a game picture frame 701 may include a 3D model of an object. 702 in FIG. 7 is a model structure of the 3D model of the object, and further a texture image may be drawn on each triangular facet of the 3D model to obtain the 3D model as shown by 701 in FIG. 7. 703 in FIG. 7 is vertex data and normal data in the model data of the object, and the model structure of the 3D model as shown by 702 in FIG. 7 can be determined based on the vertex data and the normal data.

S504 (FIG. 5): Perform, in response to a target instruction for the 3D model of the displayed target object, an operation indicated by the target instruction on the 3D model.

The target instruction may be one of a zoom-in instruction and a zoom-out instruction. The zoom-in instruction is configured for indicating to zoom in the 3D model, and the zoom-out instruction is configured for indicating to zoom out the 3D model. In this way, for the 3D model of the target object, the 3D model may be zoomed in or the zoomed out through the target instruction, so that the terminal may perform zoom-in display or zoom-out display for the 3D model accordingly.

In some aspects, the game picture frame in which the target object is located belongs to a picture frame during scene switching in the game process. The scene switching is configured for indicating changes in the game picture triggered by a user operation, for example, changes in the game picture caused by the movement of virtual characters or view switching in the game process. The cloud device constantly transmits the game picture frame to the terminal in the form of video streaming to implement switching of game scenes. Then, the game picture frame including the target object belongs to the picture frame during scene switching in the game process. In this way, the target control may be displayed for the object that needs to be clearly displayed in the game picture frame during scene switching, to trigger the clear display for the target object. Generally, this is because the target object tends to be blurry during scene switching. In this way, when the game picture frame includes a target object that needs to be clearly displayed, and the game picture frame belongs to the picture during scene switching, the target control corresponding to the target object may be displayed on the game picture frame, so that the clear display for the target object is implemented, data processing efficiency is improved, and the definition of the target object in the game picture is improved.

It may be understood that, the 3D model of the target object drawn by the terminal may not belong to the game picture frame. The zoom-out display for the 3D model does not affect the display of the game picture frame transmitted by the cloud device. That is, during the zoom-out display for the 3D model of the target object, the target object in the displayed game picture frame may not change accordingly.

In some aspects, when the 3D model of the target object is displayed, a zoom-in control for indicating to zoom in the target object may also be displayed, or a zoom-out control for indicating to zoom out the target object is displayed, or both the zoom-in control and the zoom-out control are displayed, so that the zoom-in instruction may be triggered by a touch operation on the zoom-in control of the 3D model, or the zoom-out instruction may be triggered by a touch operation on the zoom-out control of the 3D model. For example, when the user clicks the zoom-in control, zoom-in display may be performed for the 3D model based on a zoom-in proportion; and when the user clicks the zoom-out control, zoom-out display may be performed for the 3D model based on a zoom-out proportion.

In some aspects, the zoom display may be controlled by a gesture operation, for example, moving two fingers apart (triggering the zoom-in instruction) or moving two fingers together (triggering the zoom-out instruction).

In some aspects, the zoom display may also be controlled by a keyboard and mouse operation. For example, the zoom display for the displayed 3D model may be implemented by scrolling a mouse wheel while holding down a target button.

It may be understood that, since the zoom display is for the 3D model of the target object, but not for the object in the game picture frame transmitted by the cloud device, when zoom-out display is performed for the target object, the 3D model of the target object does not become blurry, so that the definition of the target object can be ensured.

In some aspects, drawing of the 3D model depends on a camera position and a rotation direction, that is, the 3D model may be translated, zoomed, and rotated. Generally, the terminal generates a user operation event based on a rotation operation for the 3D model (such as moving a mouse left and right) and transmit the user operation event to the cloud device, and the cloud device may call a graphics drawing interface such as Direct3D (a graphics drawing interface) or OpenGL (a graphics drawing interface) to update to-be-drawn angle information, for example, angle information matrix, of the 3D model. In some aspects described herein, when the 3D model is displayed, the terminal may update the to-be-drawn angle information of the 3D model based on the rotation operation for the 3D model (such as moving the mouse left and right), thereby drawing and displaying the rotated 3D model.

The data processing process for cloud gaming is described herein with reference to the accompanying drawings. FIG. 8 is an illustrative schematic diagram of a data processing process for cloud gaming. For example, first, the user operation event from the terminal may be received through a server (as shown by 801 in FIG. 8), and for users on different platforms, different servers may be configured for data processing. For example, for client games, a Windows (an operating system) server may be configured for processing, and for mobile games, a Linux (an operating system) server may be used to run an Android (an operating system) container for data processing. Further, the server may call a corresponding graphics processing unit (GPU) (as shown by 803 in FIG. 8) through a graphics drawing interface (as shown by 802 in FIG. 8) of a corresponding platform for image drawing, to obtain a game picture frame (as shown by 804 in FIG. 8). For example, for client games, a Direct3D drawing interface may be configured for drawing, and for mobile games, an OpenGL drawing interface may be configured for drawing. Then, video compression (as shown by 805 in FIG. 8) is performed on the game picture frame, so that the compressed game picture frame (that is, compressed video data) is transmitted to the terminal.

In the cloud device, data of the graphics drawing interface may be intercepted (as shown by 806 in FIG. 8) in advance to obtain model data of at least one object that needs to be clearly displayed in the process of the cloud gaming, and the indication information configured for drawing the 3D model may be intercepted (as shown by 807 in FIG. 8), so that instruction transfer (as shown by 808 in FIG. 8) is performed on the intercepted indication information to obtain the indication information in a common format. Further, the intercepted model data of the at least one object and indication information are transmitted to the terminal. After receiving the model data of the at least one object and the indication information transmitted by the cloud device, the terminal may perform model data storage (as shown by 809 in FIG. 8) and indication information translation (as shown by 810 in FIG. 8) respectively. The model data storage may be storage of an object identifier of each object in association with the corresponding model data. The indication information translation is configured for indicating to translate the indication information in the common format transmitted by the cloud device into indication information adapted to the cloud gaming, that is, performing format conversion on the indication information in the common format transmitted by the cloud device.

Further, when receiving the compressed video data transmitted by the cloud device, the terminal may perform video decompression (as shown by 811 in FIG. 8) on the compressed video data to obtain the to-be-displayed game picture frame. The terminal may display the game picture frame, and display, through a target control management component (as shown by 812 in FIG. 8), the target control corresponding to the object that needs to be clearly displayed when the game picture frame is displayed. Further, the terminal draws the 3D model of the target object based on the indication information adapted to the cloud gaming (as shown by 813 in FIG. 8) in response to the trigger operation for the target object, to display the game picture (as shown by 814 in FIG. 8). The definition of the target object in the game picture is improved to some extent, which helps to improve the gaming experience.

In one or more aspects herein, in a game process of cloud gaming, display data transmitted by a cloud device of the cloud gaming is obtained, thereby displaying a game picture frame included in the display data, and displaying a target control of a target object on the game picture frame. When a trigger operation for the target control is received, in response to the trigger operation for the target control, the target object is drawn on the displayed game picture frame based on a first position of the target object included in the display data in the game picture frame. Therefore, compared with the related art in which the game picture is displayed only based on video streaming transmitted by the cloud device, in the aspects of this application, when the game picture frame of the cloud gaming is displayed, the target object in the game picture frame can be drawn to be displayed. The definition of the drawn target object is higher than the definition of the target object in the game picture frame transmitted by the cloud device, thereby improving the display definition of the game picture of the cloud gaming.

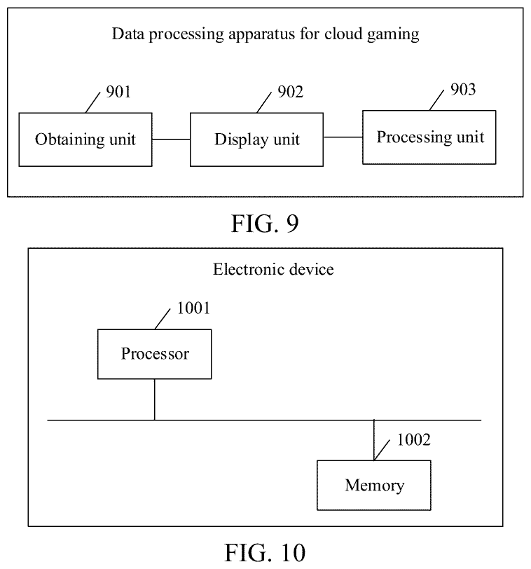

FIG. 9 is an illustrative schematic structural diagram of a data processing apparatus for cloud gaming. In some aspects, the data processing apparatus for cloud gaming may be disposed in the foregoing electronic device. As shown in FIG. 9, the data processing apparatus for cloud gaming described in this aspect of this application may include: an obtaining unit 901, configured to obtain, in a game process of cloud gaming, display data transmitted by a cloud device of the cloud gaming, the display data including a to-be-displayed game picture frame and a first position of a target object in the game picture frame; a display unit 902, configured to display the game picture frame, and display a target control of the target object on the displayed game picture frame; and a processing unit 903, configured to draw the target object on the displayed game picture frame based on the first position in response to a trigger operation for the target control.

In an illustrative implementation, the display unit 902 is further configured to display the target control of the target object at a second position associated with the first position on the displayed game picture frame.

In an illustrative implementation, the processing unit 903 is further configured to determine a third position associated with the first position on the displayed game picture frame; and draw the target object at the third position on the displayed game picture frame.

In an illustrative implementation, the processing unit 903 is further configured to draw a 3D model of the target object on the displayed game picture frame.

In an illustrative implementation, the processing unit 903 is further configured to obtain indication information configured for drawing the 3D model; and draw the 3D model of the target object on the displayed game picture frame based on an indication of the indication information.

In an illustrative implementation, the processing unit 903 is further configured to obtain model data of the target object based on the indication information; and draw the 3D model of the target object on the displayed game picture frame based on the model data of the target object and the indication information.

In an illustrative implementation, the model data of the target object includes a model key points and a texture image of the target object; and the processing unit 903 is further configured to construct a model triangular facet of the target object based on the model key points of the target object and the indication information; draw the texture image on the constructed model triangular facet of the target object based on the indication information, to obtain the drawn 3D model of the target object; and display the 3D model of the target object on the displayed game picture frame.

In an illustrative implementation, the processing unit 903 is further configured to pull initial indication information configured for drawing the three-dimensional model to the cloud device; and perform format conversion on the initial indication information to obtain indication information adapted to the cloud gaming, and store the indication information; and the obtaining unit 901 is further configured to obtain the stored indication information.

In an illustrative implementation, the processing unit 903 is further configured to pull model data of at least one object in the cloud gaming and an object identifier of the at least one object from the cloud device, the model data of the object being configured for drawing a 3D model of the object; and respectively store an object identifier and model data of each object of the at least one object in association.

In an illustrative implementation, the display data includes an object identifier of the target object; and the processing unit 903 is further configured to obtain model data stored in association with the object identifier of the target object in response to the trigger operation for the target control; and draw the 3D model of the target object on the displayed game picture frame based on the obtained model data.

In an illustrative implementation, the processing unit 903 is further configured to perform, in response to a target instruction for the drawn target object, an operation indicated by the target instruction on the drawn target object, the target instruction being one of a zoom-in instruction and a zoom-out instruction.

In an illustrative implementation, the game picture frame in which the target object is located belongs to a picture frame during scene switching in the game process.

FIG. 10 is an illustrative schematic structural diagram of an electronic device. The electronic device may include: a processor 1001 and a memory 1002. For example, the electronic device may further include a structure such as a network interface or a power supply module. Data can be exchanged between the processor 1001 and the memory 1002.

The processor 1001 may be a central processing unit (CPU). The processor may further be another general-purpose processor, a digital signal processor (DSP), an application specific integrated circuit (ASIC), a field-programmable gate array (FPGA), or another programmable logic device, a discrete gate or a transistor logic device, a discrete hardware component, or the like. The general-purpose processor may be a microprocessor, or the processor may be any conventional processor, or the like.

The network interface may include an input device and/or an output device. For example, the input device may be a control panel, a microphone, a receiver, or the like, and the output device may be a display screen, a transmitter, or the like, which are not enumerated herein.

The memory 1002 may include a read-only memory and a random access memory, and provide a computer program and data to the processor 1001. A part of the memory 1002 may further include a non-volatile random access memory. The processor is configured to call the computer program to perform the following: obtaining, in a game process of cloud gaming, display data transmitted by a cloud device of the cloud gaming, the display data including a to-be-displayed game picture frame and a first position of a target object in the game picture frame; displaying the game picture frame, and displaying a target control of the target object on the displayed game picture frame; and drawing the target object on the displayed game picture frame based on the first position in response to a trigger operation for the target control.

In an illustrative implementation, the processor 1001 is further configured to call the computer program to perform the following: displaying the target control of the target object at a second position associated with the first position on the displayed game picture frame.

In an illustrative implementation, the processor 1001 is further configured to call the computer program to perform the following: determining a third position associated with the first position on the displayed game picture frame; and drawing the target object at the third position on the displayed game picture frame.

In an illustrative implementation, the processor 1001 is further configured to call the computer program to perform the following: drawing a 3D model of the target object on the displayed game picture frame.

In an illustrative implementation, the processor 1001 is further configured to call the computer program to perform the following: obtaining indication information configured for drawing the three-dimensional model; and drawing the 3D model of the target object on the displayed game picture frame based on an indication of the indication information.

In an illustrative implementation, the processor 1001 is further configured to call the computer program to perform the following: obtaining model data of the target object based on the indication information; and drawing the 3D model of the target object on the displayed game picture frame based on the model data of the target object and the indication information.

In an illustrative implementation, the model data of the target object includes a model key points and a texture image of the target object; and the processor 1001 is further configured to call the computer program to perform the following: constructing a model triangular facet of the target object based on the model key points of the target object and the indication information; drawing the texture image on the constructed model triangular facet of the target object based on the indication information, to obtain the drawn 3D model of the target object; and displaying the 3D model of the target object on the displayed game picture frame.

In an illustrative implementation, the processor 1001 is further configured to call the computer program to perform the following: pulling initial indication information configured for drawing the three-dimensional model to the cloud device; and performing format conversion on the initial indication information to obtain indication information adapted to the cloud gaming, and store the indication information; and the processor 1001 is further configured to obtain the stored indication information.

In an illustrative implementation, the processor 1001 is further configured to call the computer program to perform the following: pulling model data of at least one object in the cloud gaming and an object identifier of the at least one object from the cloud device, the model data of the object being configured for drawing a 3D model of the object; and respectively storing an object identifier and model data of each object of the at least one object in association.

In an illustrative implementation, the display data includes an object identifier of the target object; and the processor 1001 is further configured to call the computer program to perform the following: obtaining model data stored in association with the object identifier of the target object in response to the trigger operation for the target control; and drawing the 3D model of the target object on the displayed game picture frame based on the obtained model data.

In an illustrative implementation, the processor 1001 is further configured to call the computer program to perform the following: performing, in response to a target instruction for the drawn target object, an operation indicated by the target instruction on the drawn target object, the target instruction being one of a zoom-in instruction and a zoom-out instruction.

In an illustrative implementation, the game picture frame in which the target object is located belongs to a picture frame during scene switching in the game process.

In some aspects, the computer program, when executed by the processor, may also implement other steps in the method in the foregoing aspects.

An aspect described herein further provides a computer-readable storage medium, having a computer program stored therein, the computer program, when executed by a processor, implementing the method provided in the aspects of this application. Details are not described herein again.

In some aspects, the computer-readable storage medium involved in the aspects of this application may be volatile or non-volatile.

In some aspects, the computer-readable storage medium may mainly include a program storage region and a data storage region. The program storage region may store an operating system, an application program required by at least one function, or the like; and the data storage region may store data created based on use of blockchain nodes. The blockchain in this application is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, for verifying the validity of the information of the data block (anti-counterfeiting) and generating a next block. The blockchain may include an underlying blockchain platform, a platform product service layer, an application service layer, and the like.

For case of description, the foregoing methods are described as a series of action combinations. However, persons skilled in the art should know that this application is not limited to the described order of the actions because some steps may be performed in another order or performed at the same time according to this application. In addition, a person skilled in the art is also to learn that the aspects described in this specification are all exemplary aspects, and the involved actions and modules are not necessary for this application.

A person of ordinary skill in the art may understand that all or some of the steps in the various methods described herein may be implemented by a computer program instructing relevant hardware. The computer program may be stored in a computer-readable storage medium. The computer-readable storage medium may include: a flash drive, a read-only memory (ROM), a random access memory (RAM), a magnetic disk, an optical disc, or the like.

One or more aspects described herein may further provide a computer program product or a computer program, including computer executable instructions, the computer executable instructions, when executed by a processor, implementing some or all steps in any method described herein. For example, the computer executable instructions are stored in a computer-readable storage medium. The processor of the computer device (that is, the foregoing electronic device) reads the computer executable instructions from the computer-readable storage medium, and the processor executes the computer executable instructions, to cause the computer device to perform the steps in the method aspects. For example, the computer device may be a terminal or a server.

The data processing method and apparatus for cloud gaming, the electronic device, the computer-readable storage medium, and the computer program product provided herein are described in detail above. The principles and implementations of this application are described through specific examples in this specification and the descriptions of the various aspects are only intended to help understand the methods and core ideas of this application. Meanwhile, a person of ordinary skill in the art may make modifications to the specific implementations and application scopes according to the ideas of this application. In conclusion, the content of the specification should not be construed as a limitation to this application.

What is claimed is:

1. A data processing method for cloud gaming, performed by an electronic device, the method comprising:
receiving display data for a cloud game transmitted from a cloud device of a cloud gaming system, the display data comprising a to-be-displayed game picture frame and a first position of a target object in the game picture frame;
displaying the game picture frame; and
drawing the target object on the displayed game picture frame based on the first position, using locally stored data associated with the target object.

2. The method according to claim 1, further comprising:
displaying a target control of the target object at a second position associated with the first position on the displayed game picture frame;
drawing the target object on the displayed game picture frame in response to a trigger operation for the target control.

3. The method according to claim 2, wherein the drawing the target object on the displayed game picture frame based on the first position comprises:
determining a third position associated with the first position on the displayed game picture frame; and
drawing the target object at the third position on the displayed game picture frame.

4. The method according to claim 1, wherein the drawing the target object on the displayed game picture frame comprises:
wherein the locally stored data comprises a 3D model of the target object.

5. The method according to claim 4, wherein the drawing the 3D model of the target object on the displayed game picture frame comprises:
obtaining indication information configured for drawing the 3D model; and
drawing the 3D model of the target object on the displayed game picture frame based on the indication information.

6. The method according to claim 5, wherein the drawing the 3D model of the target object on the displayed game picture frame based on the indication information comprises:
obtaining model data of the target object based on the indication information; and
drawing the 3D model of the target object on the displayed game picture frame based on the model data of the target object and the indication information.

7. The method according to claim 6, wherein the model data of the target object comprises model key points and a texture image of the target object; and
the drawing the 3D model of the target object on the displayed game picture frame based on the model data of the target object and the indication information comprises:
constructing a model triangular facet of the target object based on the model key points of the target object and the indication information;
drawing the texture image on the constructed model triangular facet of the target object based on the indication information, to obtain the drawn 3D model of the target object; and
displaying the 3D model of the target object on the displayed game picture frame.

8. The method according to claim 5, wherein before the obtaining indication information configured for drawing the 3D model, the method further comprises:
pulling initial indication information configured for drawing the 3D model to the cloud device; and
performing format conversion on the initial indication information to obtain indication information adapted to the cloud game, and storing the converted indication information; and
the obtaining indication information configured for drawing the 3D model comprises:
obtaining the converted indication information.

9. The method according to claim 1, further comprising:
pulling model data of at least one object in the cloud game and an object identifier of the at least one object from the cloud device, the model data of the object being configured for drawing a 3D model of the object; and
respectively storing locally an object identifier and associated model data of each object of the at least one object.

10. The method according to claim 9, wherein the display data comprises an object identifier of the target object; and the drawing the target object on the displayed game picture frame in response to a trigger operation for the target control comprises:
obtaining model data associated with the object identifier of the target object in response to the trigger operation for the target control; and
drawing the 3D model of the target object on the displayed game picture frame based on the obtained model data.

11. The method according to claim 2, further comprising:
performing, in response to a target instruction for the drawn target object, an operation indicated by the target instruction on the drawn target object, the target instruction being one of a zoom-in instruction and a zoom-out instruction.

12. The method according to claim 1, wherein the game picture frame in which the target object is located forms part of a scene switch in the cloud game.

13. A data processing apparatus, comprising:
an obtaining unit, configured to obtain, in a game process of a cloud game, display data transmitted by a cloud device hosting the cloud game, the display data comprising a to-be-displayed game picture frame and a first position of a target object in the game picture frame;
a processing unit, configured to draw the target object on the displayed game picture frame based on the first position using locally stored data associated with the target object.

14. One or more non-transitory computer readable media comprising computer readable instructions which, when executed configure a cloud gaming client device to perform:
receiving display data for a cloud game transmitted from a cloud device of a cloud gaming system, the display data comprising a to-be-displayed game picture frame and a first position of a target object in the game picture frame;
displaying the game picture frame; and
drawing the target object on the displayed game picture frame based on the first position using a locally stored model corresponding to the target object.

15. A cloud gaming method comprising:
generating display data for a cloud game, the display data comprising a to-be-displayed game picture frame, a 3D model for a target object, and a first position of the target object in the game picture frame; and
sending the display data to a client device for rendering as part of a cloud gaming session.

16. The cloud gaming method of claim 15, wherein the 3D model of the target object comprises model key points and a texture image of the target object.

17. The cloud gaming method of claim 15, further comprising:
determining initial indication information configured for drawing the 3D model;
converting a format of the initial indication information based on the client device and/or the cloud game;
storing the converted indication information; and
sending the converted indication information with the display data.

18. The cloud gaming method of claim 15, further comprising associating an object identifier with the 3D model.

19. One or more non-transitory computer readable media comprising computer readable instructions which, when executed configure a cloud device to perform:
generating display data for a cloud game, the display data comprising a to-be-displayed game picture frame, a 3D model for a target object, and a first position of the target object in the game picture frame; and
sending the display data to a client device for rendering as part of a cloud gaming session.

20. The computer readable media of claim 19, further comprising computer readable instructions which, when executed configure the cloud device to perform:
determining initial indication information configured for drawing the 3D model;
converting a format of the initial indication information based on the client device and/or the cloud game;
storing the converted indication information; and
sending the converted indication information with the display data.
